(19) United States
(12) Patent Application Publication
(10) Pub. No.: US 2008/0293317 A1
(43) Pub. Date: Nov. 27, 2008

(54) Stretch Fabrics with Wrinkle Resistance

(76) Inventors: Antonio Batistini, Wangen (CH); Tong Gao, Singapore (SG); Jerry C.T. Wang, Taichung (CN)

Correspondence Address: The Dow Chemical Company, Intellectual Property Section, P.O. Box 1967, Midland, MI, 48641-1967, US

(21) Appl. No.: 11/629,006

(22) PCT Filed: Jun. 20, 2005
(86) PCT No.: PCT/US05/21728

§ 371 Date: Dec. 8, 2006

Related U.S. Application Data
(60) Provisional application No. 60/582,660, filed on Jun. 24, 2004.

(51) Int. Cl. B32B 5/02

(52) U.S. Cl. 442/107

(57) ABSTRACT

The present disclosure is directed to stretch or elastic textile articles having wrinkle resistance. The textile articles are preferably cellulosic, more preferably cotton-based. The stretch levels for these articles is preferably greater than about 8 percent and preferably have a DP rating (as determined according to AATCC 143-1996 or AATCC 124-2001) of at least 3.0.

The present invention relates to stretch fabrics having improved wrinkle resistance. In one aspect, the invention relates to stretch fabrics comprising synthetic fibers and natural fibers (particularly cotton) where the synthetic fibers comprise crosslinked, heat-resistant elastic fibers capable of withstanding chemical treatments commonly used to impart wrinkle resistance on fabrics. Another aspect of the invention are articles of manufacture, such as garments, which have been made from such fabrics and which exhibit resistance to wrinkling.

As textile articles such as linens and garments are used, wrinkles appear on the article's surface. In the case of garments, particularly cellulosic-based garments, wear and especially the laundering of the garments causes wrinkles which results in a generally undesirable appearance. To remove the wrinkles, consumers of the garment use a variety of methods including ironing, pressing and even closely monitored tumble drying. Frequent or difficult wrinkling leads to consumer dissatisfaction. Manufacturers and designers of textile articles have sought to give the articles a durable press such that the articles exhibit the ability to avoid wrinkle formation and/or the ability to quickly remove the wrinkles with minimal effort. Typical durable press coatings involve the application of a chemical coating to the surface of the textile. These coatings typically include a cross-linking agent and catalyst such that cross-links between the agent and the cellulose in the fibers of the textile form. These crosslinks not only provide wrinkle resistance but may also improve dimensional stability, increase fabric smoothness and improve crease retention.

The chemical coatings which are often currently used to impart wrinkle resistance to a textile article, are relatively harsh. While suitable for many fabrics, such treatments have not been successful when applied to stretch fabrics as the spandex fibers which are commonly used to impart stretch to a fabric do not endure either chemical treatment or heat (curing) treatment. Thus there are currently no stretch fabrics exhibiting wrinkle resistance. Thus there is a need for wrinkle resistant stretch fabrics, and particularly cellulosic-based wrinkle resistant stretch fabrics.

The present disclosure is directed to stretch or elastic textile articles having wrinkle resistance. The textile articles are preferably cellulosic, more preferably cotton-based. The stretch levels for these articles is preferably greater than about 10 percent and these articles preferably have a DP rating (as determined according to AATCC 143-1996 for garments or AATCC 124-2001 for fabrics) of at least 3.0.

The present invention is directed to textile articles having stretch and being wrinkle resistant. For purposes of the present invention, “textile articles” includes finished fabric as well as articles made from the fabric including bedsheets and other linens and garments. A material is typically characterized as elastic (or as having stretch) if it has a high percent elastic recovery (that is, a low percent permanent set) after application of a biasing force. Ideally, elastic materials are characterized by a combination of three important properties, that is, (i) a low stress or load at strain; (ii) a low percent stress or load relaxation, and (iii) a low percent permanent set. In other words, there should be (i) a low stress or load requirement to stretch the material, (ii) zero or low relaxing of the stress or unloading once the material is stretched, and (iii) complete or high recovery to original dimensions after the stretching, biasing or straining is discontinued.

For the purposes of this invention, an article is considered to be “elastic” or to be a “stretch” article if the article can be stretched at least eight percent in the warp or weft direction (that is, at least 1.08 times its original length), preferably at least ten percent, and then the fabric returns to a value closer to its original dimensions after release of the stretching force as per ASTM D3107-1980. The fabrics of the present invention should have a ratio of percent growth to percent stretch of less than 0.5, more preferably less than 0.4, still more preferably less than 0.3 (for example, a fabric which stretches 25 percent and which recovers to a value 5 percent greater than original dimension would have a ratio of 0.2). It should be understood that the amount of stretch and recovery will be a function of the weight of the fabric (that is, lighter weight fabrics such as voile will generally have more stretch and less recovery) and the fabric construction (for example, herringbone fabrics are known to have greater stretch). In some instances the article can be stretched at least 15 percent, and even at least 25 percent, in the warp or weft direction. It is also contemplated that the articles of the present invention will have stretch in more that one direction, and indeed for many applications this will be preferred. It is not necessary that the articles have stretch in more than one direction or that the articles have the same amount of stretch in each direction to be within the scope of this invention.

The second criteria for the textile articles of the present invention is that they be wrinkle resistant. Wrinkle resistance in the textile industry can be measured according to AATCC 143-1996 (for garments) or AATCC-124-2001 (for finished fabric). Using this testing protocol, the articles of the present invention will have a durable press (or DP) rating of at least 3.0 after five washes, more preferably at least 3.5 and most preferably at least about 4.0. Ideally the DP rating will remain at least 3.0 after 25 or even 50 washes.

The textile articles of the present invention preferably include cellulosic materials such as cotton, flax (linen), ramie, rayon, viscose and/or hemp. Preferably, the cellulosic materials will comprise 60 to 98 percent by weight of the textile article, more preferably greater than about 90 percent. It is preferred that the fabrics comprise cotton. One or more other materials can also be used in the textile articles of the present invention, either alone or preferably in combination with cellulosic materials. These other materials include natural fibers such as wool, silk or mohair and synthetic fibers such as polyester, polyamide or polypropylene.

In order to give elasticity, the articles of the present invention will also comprise an elastic fiber. For purposes of the present invention an elastic fiber is one that will recover at least about 50 percent, more preferably at least about 60 percent even more preferably 70 percent of its stretched length after the first pull and after the fourth to 100 percent strain (double the length). One suitable way to do this test is based on the one found in the International Bureau for Standardization of Manmade Fibers, BISFA 1998, chapter 7, option A. Under such a test, the fiber is placed between grips set 4 inches apart, the grips are then pulled apart at a rate of about 20 inches per minute to a distance of eight inches and then allowed to immediately recover.

The preferred elastic fiber for use in the present invention is crosslinked homogeneously branched ethylene polymers. This material is described in U.S. Pat. No. 6,437,014, and is generically known as lastol. Such fibers are available from The Dow Chemical Company under the trade name Dow XLA fibers. It is preferred that the elastic fibers comprise from 2 to 10 percent by weight of the article. The elastic fiber may be of any suitable thickness with fibers in the range of 20 to 140 denier being generally preferred due to their availability with 40 to 70 denier fiber being the most common for this application.

The elastic fiber may be used neat, or it may first be incorporated into a multifilament yarn. In many applications the elastic fiber may advantageously be wrapped with a natural fiber, such as cotton.

In some applications, such as pants, it is desired that the article maintains a crease. This desire to maintain a crease often conflicts with technical solutions used to deter wrinkles. It has surprisingly been found, that the preferred textile articles of the present invention exhibit a Crease Retention (“CR”) rating of at least 3.5, as determined according to the testing protocol set forth in AATCC 143-1996. AATCC 143-1996 3(IV)A(iii), is especially preferred for determining CR. Accordingly, the textile articles of the present invention will preferably have a CR of at least 3.0, more preferably 3.5 most preferably 4.0.

The articles of the present invention are not limited by the method of making them. Thus, the articles of the present invention include fabrics which have been woven (where the elastic fiber can be in the warp direction, the weft direction or both) or knitted.

Similarly, any method known to impart wrinkle resistance may be used with the textile articles of the present invention. Typically fabrics are prepared and then a finishing solution containing a cross-linking agent together with a catalyst is applied. The application of the finishing solution can be applied to the fabric or to the finished article, as is known in the art. In general, the crosslinking agent and curing catalyst are applied by immersing the cellulosic material into a bath containing the finishing solution, but other methods such as spraying, are known and can be used to make the textile articles of the present invention. Another method for producing wrinkle-resistant garments involves subjecting a pressed garment in a reaction chamber containing sulphur dioxide, formaldehyde and steam, where cross-linking of cellulose occurs in situ. Typical cross-linking agents include formaldehyde, formaldehyde derivatives (including addition products with urea) and carbamate esters. Other cross-linking agents are described in WO 89/12714 (organic polycarboxylic acids), U.S. Pat. No. 5,300,240 (phosphinicosuccinic and/or phosphinicobisuccinic acids); U.S. Pat. No. 6,585,780 (phosphinato-substituted polycarboxylic acids) and US 2003/0111633 A1. These references are hereby incorporated by reference in their entirety.

The selection of non-elastic fibers used in the fabric may depend on the desired fabric construction and the process used to impart wrinkle resistance to the fabric, so as to ensure that the fibers selected have suitable tenacity. For example, if a lightweight cotton-containing fabric is desired and a relatively harsh chemical treatment will be used to impart wrinkle resistance, then it may be advantageous to use a cotton fiber with higher initial tenacity, such as PIMA cotton, so that the fibers in the finished fabric will still have acceptable tenacity.

### EXAMPLES

### Example 1

### Moisture Cure

To demonstrate the present invention the following plain weave woven fabric was prepared: CPT40×CM80/2+SUPIMA40+70DXLA/120×74,53/54 (that is a plain weave of 120 ends/inch×74 picks/inch, and a finished fabric width of 53-54 inches, where the warp yarn is compact cotton yarn Ne40; and the weft yarn is a combination of combed cotton yarn Ne80/2 ply and core spun yarn of SUPIMA cotton Ne40 with 70 denier DOW XLA fiber).

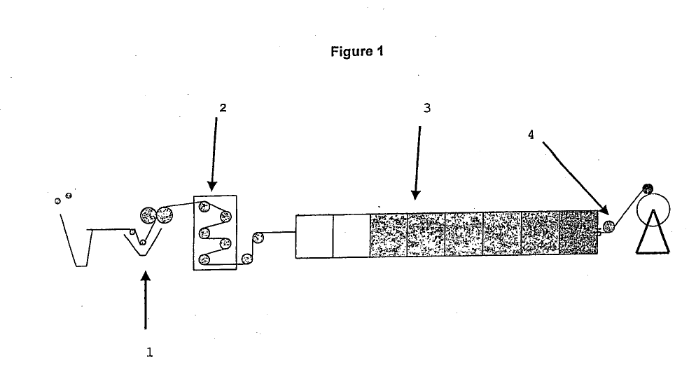

After the fabric was woven, it was subjected to a finishing process which included the steps of desizing, bleaching, treating with liquid ammonia, and pre-softening. After this finishing process the fabrics were then subjected to a non-wrinkling treatment. The nowrinkling treatment consisted of a chemical dip followed by moisture cross-linking (moisture X-link). The device used to apply the non-wrinkling treatment was a Monforts Montex 5000 as depicted in FIG. 1. The non-wrinkling chemical bath (1) was an aqueous solution containing 3 g/l Cognis BF 5527, 3.4 g/l 48° Be NaOH, 6.8 g/l 28° percent H202, 0.48 percent of ABPL whitener (High Aff). The liquor/substrate ratio in the bath was maintained at about 12:1. The pH of the bath was kept between 1.5 and 1.8. The Pre-heater (2) was off (dwell only), and the speed of the fabric through the dryer (3) was set at 43 m/min. The dryer unit (3) was set to have a temperature gradients from 70° C. to 95° C. The Air Circulation within the dryer unit (3) was set to maintain a relative humidity of approximately 65 percent rh. The fabric was then wound onto rolls and these rolls were kept at a temperature of 30 to 35° C. for a period of 16-24 hours to allow for crosslinking.

After treating the fabrics they were measured to determine stretch and growth according to ASTM D3107; and DP rating according to AATCC-124-2001 TEST NO. 1 (IV)A(i) after 5 washes. These values are reported in Table 1. Table 1 also contains tensile strength and tear strength for Example 1. The tensile strength was determined according to ASTM D 5034; and the tear strength was determined according to ASTM D 1424.

### Examples 2-4

### Garment Dipping

A second set of experiments were carried out on garments which had been dipped in a wrinkle resistant solution. The garments were made from the following fabrics: Example 2 was a twill fabric of 144×75 50×CVC 45+70D XLA (core spun Dow XLA fiber). (that is a Twill of 144 ends/inch×75 picks/inch, and a finished fabric width of 53-54 inches, where the warp yarn is cotton yarn NeSO; and the weft core spun yarn is CVC (50 percent Cotton 50 percent polyester) yarn Nse 45 with 70 denier DOW XLA fiber;).

Example 3 was a poplin fabric of 144×75 50×cvc45(core spun XLA). (that is Poplin of 144 ends/inch×75 picks/inch, where the warp yarn is cotton yarn Ne50; and the weft core spun yarn is CVC (50 percent Cotton 50 percent polyester) yarn Ne 45 with 70 denier DOW XLA fiber;).

Example 4 was a pinpoint oxford of 75 percent C 22 percent Dow XLA fiber 160×72 80/2//×cvc 45 (core spun Dow XLA fiber) (that is Pinpoint Oxford of 160 ends/inch×72 picks/inch, where the warp yarn is cotton yarn Ne 80/2 ply, and the weft core spun yarn is CVC (50 percent Cotton 50 percent polyester) yarn Ne 45 with 70 denier DOW XLA fiber;).

The above fabrics were desized, dyed, finished, then made into garments. The garments were then subjected to a dipping process as described in US 2003/0111633 AI, herein incorporated by reference in its entirety. After dipping, the garment was removed, partially dried, pressed and cured.

After treating the garments, they were measured to determine stretch (elongation) and growth according to ASTM D3107; and DP rating according to AATCC 143-1996 3(W)A(iii) after 5 washes. These values are reported in Table 1 Table 1 also contains tensile strength and tear strength. The tensile strength was determined according to ASTM D 5034; and the tear strength was determined according to ASTM D 1424.

TABLE 1

| Ex- | | | | | |
|---|---|---|---|---|---|
| am- | | | | | |
| ple | | | | Tear | DP |
| # | Elongation | Growth | Tensile strength | strength | rating |
| 1 | 20.8% | 4.0% | Warp-54.75 lb | Warp-1270 g | 3.5 |
| | | | Weft-31.7 pounds | Weft-900 g | |
| 2 | Warp | Warp 0.8% | Warp-56.96 lb. | Warp-800 g | 3.8 |
| | 6.8% | | | | |
| | Weft | Weft 1.0% | Weft-50 lb. | Weft 960 g | |
| | 8.4% | | | | |
| 3 | 9.8% | 0.0% | Warp 124 lb. | Greater | 4.0 |
| | | | Weft 71.5 lb | than 7.02 | |
| | | | | lbs in both | |
| | | | | Warp and | |
| | | | | weft | |
| | | | | direction | |
| 4 | Warp | Warp 0.6% | Warp 70.62 lb. | Warp 1728 g | 3.8 |
| | 4.6% | | | | |
| | Weft | Weft 2.6% | Weft 40 lb. | Weft 1152 g | |
| | 13.6% | | | | |
| 5 | 4% | 2.2% | Warp 62 lb. | Warp 1920 g | 3.5 |
| | | | Weft 30 lbs | Weft 800- | |
| | | | | 928 g | |

What is claimed is:

1. A wrinkle resistant stretch article wherein the article has a stretch of at least 8 percent, and a DP rating of at least 3.0.

2. The article of claim 1 wherein the article comprises cellulosic fibers.

3. The article of claim 2 wherein the cellulosic fibers comprise 60 to 97 percent by weight of the article.

4. The article of claim 3 wherein the cellulosic fibers comprise at least 90 percent by weight of the article

5. The article of claim 3 wherein the cellulosic fibers include cotton fibers.

6. The article of claim 1 wherein the article has a stretch greater than 10 percent.

7. The article of claim 6 wherein the article has a stretch greater than 15 percent.

8. The article of claim 7 wherein the article has a stretch greater than 25 percent.

9. The article of claim 1 wherein the article has a DP rating of at least 3.5.

10. The article of claim 9 wherein the article has a DP rating of at least 4.0.

11. The article of claim 1 wherein the article comprises fiber made from one or more crosslinked polyolefin polymers.

12. The article of claim 10 wherein at least one of the crosslinked polyolefin polymers is a homogeneously branched ethylene polymer.

13. The article of claim 11 wherein the fiber made from crosslinked polyolefin polymer comprises 2 percent to 10 percent by weight of the article.

14. The article of claim 1 further characterized as having a Crease Retention rating of at least 3.5.

15. The article of claim 1 wherein the article is in the form of a garment.

16. The article of claim 1 wherein the article is in the form of a linen.

17. A wrinkle resistant stretch article wherein the article has a stretch of at least 10 percent, and a CR rating of at least 3.0.

18. The article of claim 1 wherein the article comprises elastic fiber made from one or more crosslinked polyolefin polymers and one or more non-elastic fibers selected from the group consisting of cotton, flax, ramie, rayon, viscose, hemp, wool, silk, mohair, polyester, polyamide and polypropylene fibers.
